(19) United States
(12) Patent Application Publication
(10) Pub. No.: US 2013/0240568 A1
(43) Pub. Date: Sep. 19, 2013

(54) MOLTEN WAX PUMPING DEVICE AND MOLTEN WAX DISPENSER USING SAME

(71) Applicant: Yu-Sheng Shiau, Taoyuan County (TW)

(72) Inventor: Yu-Sheng Shiau, Taoyuan County (TW)

(21) Appl. No.: 13/424,128

(22) Filed: Mar. 19, 2012

(51) Int. Cl. F04B 19/22; B67D 7/00; F04B 15/04

(52) U.S. Cl. 222/255; 417/437

(57) ABSTRACT

A molten wax pumping device includes a pump body defining a pump hole and a material outlet, a pump rod inserted through the pump hole of the pump body, and a linear driving device affixed to the pump body for reciprocating the pump rod to pump molten wax out of a molten wax tank of a molten wax dispenser into the pump hole toward the material outlet. One or more molten wax pumping devices can be mounted to the molten wax tank for pumping out molten wax.

### BACKGROUND OF THE INVENTION

(a) Field of the Invention The present invention relates to electrical wax injection technology and more particularly to a molten wax pumping device and a molten wax dispenser using the molten wax pumping device.

(b) Description of the Prior Art

Lost-wax casting is a method of metal casting in which a special wax is injected into a metal die, creating patterns that are compiled into a cluster around a wax runner system. After the pattern is coated with layers of refractory material, it is then heated to drain the wax. Once the wax is drained away, a hot mold is cast. After cooling, the mold is removed through the use of vibration, high pressure water blasting, impacting, grit blasting, or chemical dissolution. This process is practical for casting fine products. When making a wax mold, many devices are needed, including a wax melting machine, a molten wax dispenser and a wax injection machine. During a wax mold fabrication process, solid wax is melted by a wax melting machine, and then the molten wax is filled into a molten wax dispenser where the temperature of the molten wax is regulated, and then the molten wax is dispensed into a wax injection machine for injection into a mold die.

During the operation of the molten wax dispenser to dispense the molten wax into the wax injection machine, a molten wax pumping device should be used to pump the molten wax out of the molten wax dispenser into the wax injection machine. A conventional molten wax pumping device for this purpose generally comprises a pump body, a piston and a driving mechanism. The pump body comprises an inlet, an outlet, and two check valves respectively mounted in the inlet and the outlet. The inlet of the pump body is connected to the molten wax dispenser. The outlet of the pump body is connected to the wax injection machine. The piston is mounted in the pump body and alternately moved back and forth in the pump body to draw the molten wax into the inlet and to force the intake molten wax out of the outlet. The driving mechanism is adapted for reciprocating the piston.

According to the aforesaid pumping method, two check valves must be respectively mounted in the inlet and outlet of the pump body to restrict the flowing direction of the molten wax during the pumping operation. The use of the check valves in the pump body complicates the structure of the molten wax pumping device and increases the maintenance frequency. During the pumping action, the molten wax pumping device may be unable to draw in a sufficient amount of the molten wax, leading to low efficiency.

Therefore, there is a strong demand for a molten wax pumping device for the molten wax dispenser, which eliminates the aforesaid drawbacks.

### SUMMARY OF THE INVENTION

The present invention has been accomplished under the circumstances in view. It is one object of the present invention to provide a molten wax pumping device and a molten wax dispenser using same, which has the advantages of simple structural design, ease of maintenance and high molten wax pumping efficiency.

It is another object of the present invention to provide a molten wax pumping device and a molten wax dispenser using same, which uses a linear reciprocating device to reciprocate a pump rod in an out of a pump body, thereby pumping a molten wax out of a molten wax tank into a pump hole in the pump body toward a material outlet. During the forward stroke of the pump rod, a piston at one end of the pump rod is out of the pump hole of the pump body, allowing the molten wax to flow out of the molten wax tank into the pump hole. During the back stroke of the pump rod, the piston is moved with the pump rod into the inside of the pump hole of the pump body, forcing the intake molten wax out of the pump hole into the material outlet toward a wax injection machine or other equipment.

It is still another object of the present invention to provide a molten wax pumping device and a molten wax dispenser using same, which enables the molten wax in the molten wax tank to be regulated to an optimal temperature for pumping by the molten wax pumping device to a wax injection machine or other equipment.

### BRIEF DESCRIPTION OF THE DRAWINGS

FIG. 1 is an exploded view of a molten wax pumping device in accordance with the present invention.

FIG. 2 is a sectional perspective view of the molten wax pumping device in accordance with the present invention.

FIG. 3 is a sectional view of the molten wax pumping device in accordance with the present invention.

FIG. 4 is a sectional perspective view of a molten wax dispenser in accordance with the present invention.

FIG. 5 is a sectional view of the molten wax dispenser in accordance with the present invention.

FIG. 6 is a schematic drawing of the present invention, illustrating the pumping operation of the molten wax pumping device during a forward stroke of the pump rod.

FIG. 7 is a schematic drawing of the present invention, illustrating the pumping operation of the molten wax pumping device during a backward stroke of the pump rod.

### DETAILED DESCRIPTION OF THE PREFERRED EMBODIMENTS

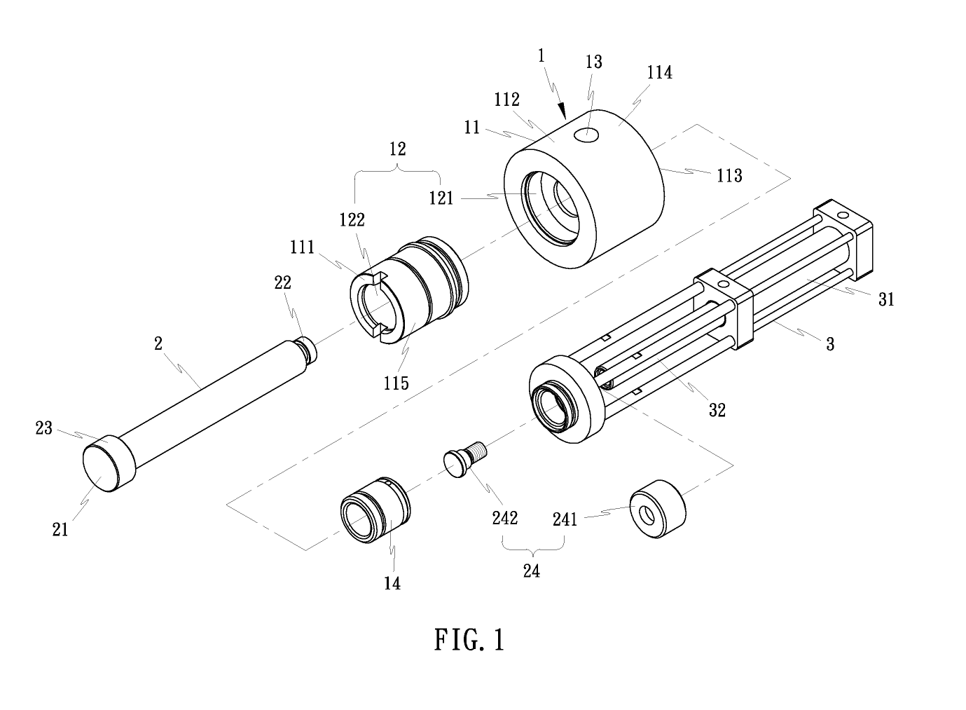

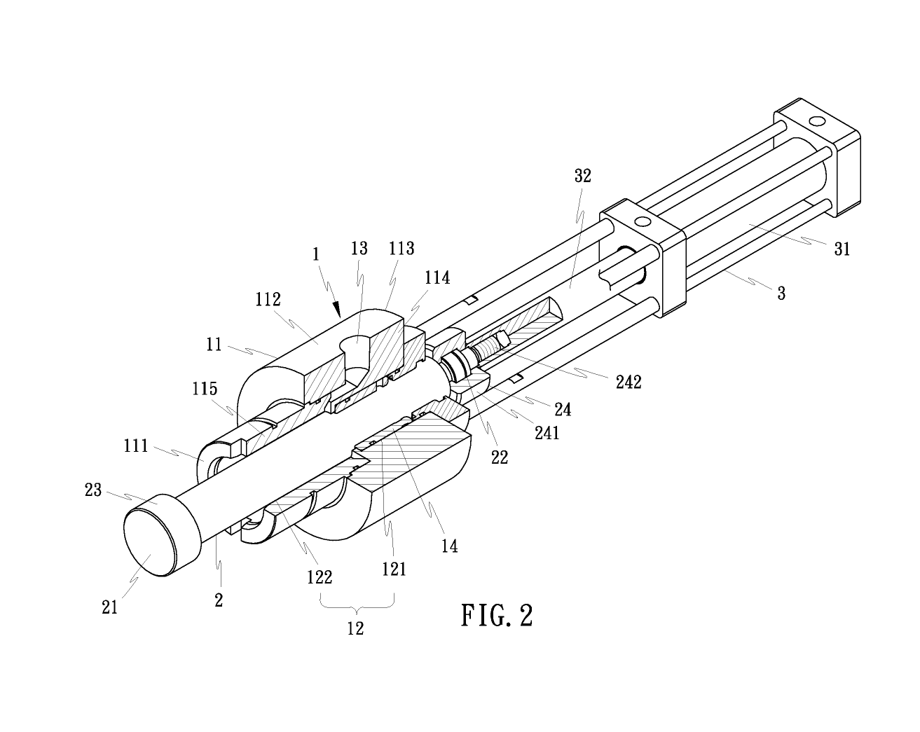

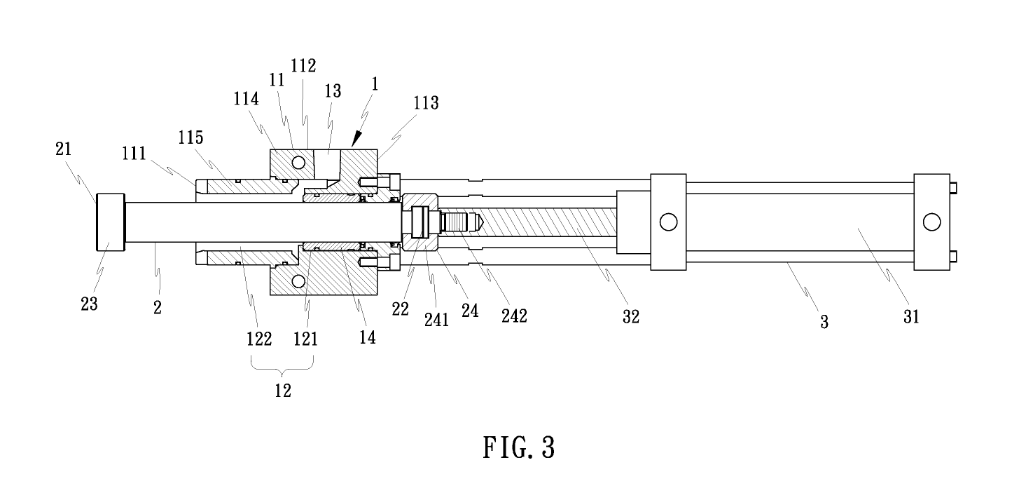

Referring to FIGS. 1-4, a molten wax pumping device in accordance with the present invention is installed in a molten wax dispenser 10. The molten wax pumping device comprises a pump body 1, a pump rod 2, and a linear driving device 3.

The pump body 1 comprises a body shell 11, a pump hole 12, and a material outlet 13. The body shell 11 comprises a first end 111 mountable to the molten wax dispenser 10 for communication with the inside space of the molten wax dispenser 10, a peripheral wall 112, and a second end 113 opposite to the first end 111. The pump hole 12 is a through hole communicating the first end 111 and the second end 113 for receiving a molten wax from the molten wax dispenser 10. The material outlet 13 is formed in the peripheral wall 112 of the body shell 11, and kept in communication with the pump hole 12 for the output of the molten wax. Alternatively, the material outlet 13 can be disposed beyond the peripheral wall 112 and kept in communication with the second end 113 for the output of the molten wax.

The pump rod 2 is an elongated rod member, comprising opposing pumping end 21 and connecting end 22, a piston 23 mounted on the pumping end 21 and fitting the pump hole 12. The pump rod 2 is inserted through the pump hole 12 of the pump body 1, and drivable to move the piston 23 out of the pump hole 12 and the first end 111 of the body shell 11 for letting the molten wax flow into the pump hole 12, or into the first end 111 of the body shell 11 and the pump hole 12 in forcing the intake molten wax toward the material outlet 13.

The linear driving device 3 is connected to the second end 22 of the pump rod 2, and adapted for reciprocating the pump rod 2 relative to the pump body 1. The linear driving device 3 can be a pneumatic cylinder, hydraulic cylinder, or any other similar mechanism capable of reciprocating the pump rod 2. According to this embodiment, the linear driving device 3 is a hydraulic cylinder consisting of a cylinder body 31 and a reciprocating rod 32. The reciprocating rod 32 is movably coupled to the cylinder body 31 and connected to the connecting end 22 of the pump rod 2.

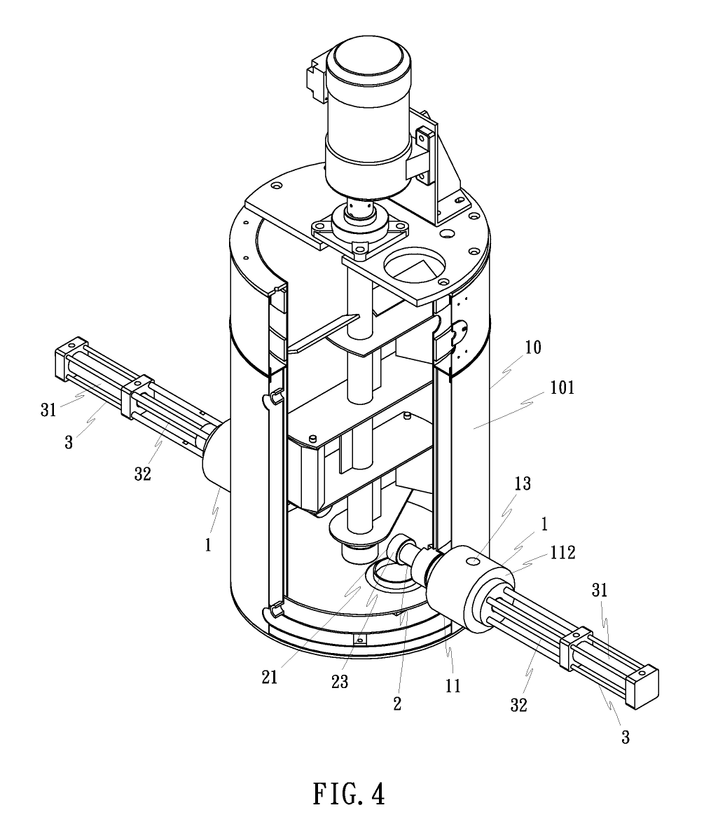

The pump body 1, the pump rod 2 and the linear driving device 3 are assembled to form the molten wax pumping device. As illustrated in FIG. 4, the molten wax pumping device is installed in the e molten wax dispenser 10 for pumping the molten wax out of the molten wax dispenser 10 to a wax injection machine or any other equipment.

Further, the aforesaid pump body 1 is a single piece member. Alternatively, the pump body 1 can be formed of two members. As illustrated in FIGS. 1-3, the pump body 1 comprises a receiving barrel 114 and a connecting barrel 115. The receiving barrel 114 can be a hollow cylindrical or rectangular shell forming the second end 113 and defining therein a first pump hole segment 121 of the pump hole 12. The connecting barrel 115 is a hollow cylindrical member, having one end thereof connected to the receiving barrel 114 and an opposite end thereof forming the aforesaid first end 111. Further, the connecting barrel 115 defines therein a second pump hole segment 122 of the pump hole 12. The first pump hole segment 121 and the second pump hole segment 122 form the pump hole 12.

Referring to FIGS. 1-3 again, to avoid molten wax leakage, the pump body 1 is equipped with a tubular gasket 14. The tubular gasket 14 fits the pump hole 12. Further, the tubular gasket 14 is mounted in the pump hole 12 (i.e., the first pump hole segment 121) adjacent to the second end 113. The pump rod 2 is movably inserted through the tubular gasket 14, with the connecting end 22 suspended outside the second end 113 of the pump body 1 for the connection of the linear driving device 3. Thus, the tubular gasket 14 effectively prevents molten wax leakage.

Referring to FIGS. 1-3 again, a connector 24 is provided at the connecting end 22 of the pump rod 2 and connected to the reciprocating rod 32 of the linear driving device 3, allowing the linear driving device 3 to reciprocate the pump rod 2. The connector 24 comprises a cap ring 241 fastened to the connecting end 22 of the pump rod 2, and a fastening member, for example, tie screw 242 mounted in the cap ring 241 and fastened to the reciprocating rod 32 of the linear driving device 3. Further, the cylinder body 31 of the linear driving device 3 can be mounted at the second end 113 or other part of the pump body 1 for enabling the reciprocating rod 32 to reciprocate the pump rod 2.

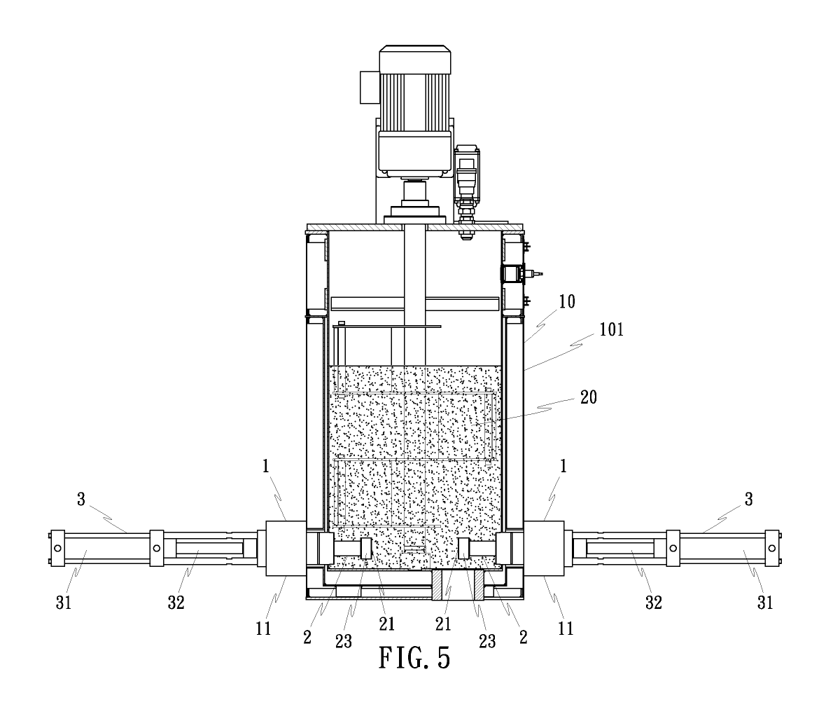

Referring to FIG. 5 and FIG. 4 again, the molten wax dispenser 10 comprises a molten wax tank 101. The pump body 1 of the molten wax pumping device is affixed to the molten wax tank 101 at one side, keeping the first end 111 of the body shell 11 and the pumping end 21 of the pump rod 2 inside the molten wax tank 101 for pumping out the storage molten wax 20. In this application example, two molten wax pumping devices are mounted in the molten wax tank 101 at two opposite sides, and controlled to pump the storage molten wax 20 alternatively, enhancing molten wax dispensing efficiency.

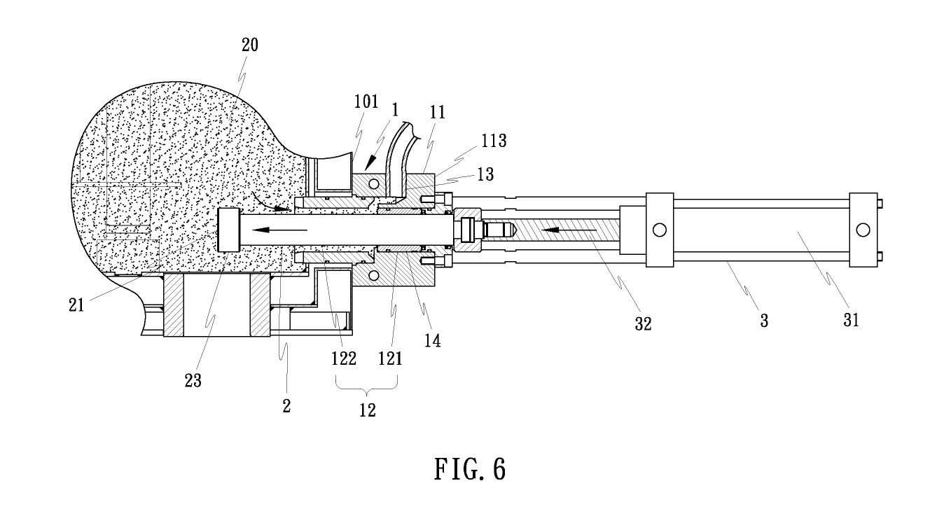

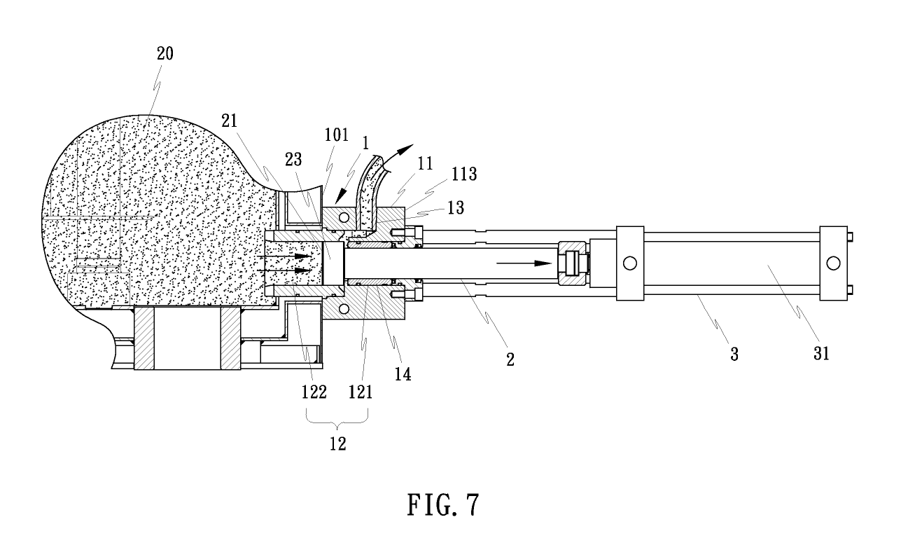

Referring to FIGS. 6 and 7, during the operation of the linear driving device 3, the reciprocating rod 32 carries the piston rod 2 alternately back and forth, thereby pumping the storage molten wax 20 out of the molten wax tank 101 to a wax injection machine or other equipment. During the forward stroke of the pump rod 2, as shown in FIG. 6, the piston 23 is moved with the pumping end 21 out of the pump hole 12 of the pump body 1, allowing the storage molten wax 20 to flow into the pump hole 12. On the contrary, as shown in FIG. 7, during the backward stroke of the pump rod 2, the piston 23 is moved with the pumping end 21 into the inside of the pump hole 12 of the pump body 1, forcing the intake molten wax 20 out of the pump hole 12 into the material outlet 13 toward a wax injection machine or other equipment.

Although a particular embodiment of the invention has been described in detail for purposes of illustration, various modifications and enhancements may be made without departing from the spirit and scope of the invention. Accordingly, the invention is not to be limited except as by the appended claims.

What is claimed is:

1. A molten wax pumping device for mounting to a molten wax tank of a molten wax dispenser for pumping molten wax out of said molten wax tank, said molten wax pumping device comprising:
a pump body comprising a body shell, a pump hole and a material outlet, said body shell comprising a first end for connecting to said molten wax tank of said molten wax dispenser, a peripheral wall and a second end opposite to said first end, said pump hole communicating said first end and said second end for receiving molten wax from said molten wax tank of said molten wax dispenser, said material outlet being formed in said peripheral wall of said body shell and kept in communication with said pump hole;
a pump rod comprising a pumping end, a connecting end opposite to the pumping end, and a piston mounted on said pumping end, said pump rod being inserted through said pump hole of said pump body and drivable to move said piston in and out of said pump hole to pump said molten wax out of said molten wax tank of said molten wax dispenser into said pump hole toward said material outlet; and
a linear driving device connected to said second end of said pump rod and adapted for reciprocating said pump rod relative to said pump body.

2. The molten wax pumping device as claimed in claim 1, wherein said pump hole comprises a first pump hole segment and a second pump hole segment; said body shell comprises a receiving barrel and a connecting barrel, said receiving barrel forming said second end of said body shell and defining therein said first pump hole segment of said pump hole, said connecting barrel having one end thereof connected to said receiving barrel and an opposite end thereof forming said first end of said body shell, said connecting barrel defining therein said second pump hole segment of said pump hole.

3. The molten wax pumping device as claimed in claim 2, wherein said pump body further comprises a tubular gasket mounted in said first pump hole segment of said pump hole;
said pump rod is movably inserted through said tubular gasket, with said connecting end suspended outside said second end of said pump body and connected to said linear driving device.

4. The molten wax pumping device as claimed in claim 1, wherein said linear driving device comprises a cylinder body, and a reciprocating rod coupled to said cylinder body and connected to said connecting end of said pump rod.

5. The molten wax pumping device as claimed in claim 4, further comprising a connector connecting said pump rod to said linear driving device.

6. The molten wax pumping device as claimed in claim 5, wherein said connector comprises a cap ring fastened to said connecting end of said pump rod and a fastening member mounted in said cap ring and fastened to said reciprocating rod of said linear driving device.

7. The molten wax pumping device as claimed in claim 5, wherein said cylinder body of said linear driving device is mounted at said second end of said pump body.

8. A molten wax dispenser, comprising a molten wax tank holding molten wax, and at least one molten wax pumping device constructed according to claim 1, the pump body of each said molten wax pumping device being affixed to said molten wax tank at one side in such a manner that the first end of the body shell and the pumping end of the pump rod of each said molten wax pumping device are kept inside said molten wax tank for pumping out said molten wax out of said molten wax tank.

9. The molten wax dispenser as claimed in claim 8, which comprises two molten wax pumping devices respectively mounted in said molten wax tank at two opposite sides.
